(19) United States
(12) Patent Application Publication
(10) Pub. No.: US 2021/0134583 A1
(43) Pub. Date: May 6, 2021

(54) ION GUIDE DEVICE WITH DC FIELD AND ASSOCIATED METHODS

(71) Applicant: SHIMADZU CORPORATION, Kyoto (JP)

(72) Inventors: Yupeng CHENG, Shanghai (CN); Xiaoqiang ZHANG, Shanghai (CN); Wenjian SUN, Shanghai (CN)

(21) Appl. No.: 16/499,402

(22) PCT Filed: May 18, 2017
(86) PCT No.: PCT/JP2017/018712

§ 371 Date: Sep. 30, 2019

(30) Foreign Application Priority Data
Apr. 19, 2017 (CN) 201710256210.0

(51) Int. Cl. H01J 49/42; H01J 49/06

(52) U.S. Cl. CPC H01J 49/426; H01J 49/063

(57) ABSTRACT

The present invention discloses an ion guide device and associated method as well as a mass spectrometer. A pair of parallel electrode assemblies, among the electrode assemblies surrounding a spatial axis to form an ion transmission channel, is segmented along a certain direction, so that a DC voltage can be separately applied to the segmented electrodes to form a DC potential gradient. In this way, not only one axial electric field component along the said spatial axis but also the other component in the direction perpendicular to the said spatial axis can be provided to control the motion of ions in the ion transmission channel. As a result, the previous problems of low analysis speed, limited ion incident energy, difficulty to balance the device structure simplification and the performance optimization and the like are solved.

### CROSS-REFERENCE TO RELATED PATENT APPLICATIONS

This application is a U.S. national stage entry of PCT Application Serial No. PCT/JP2017/018712, filed May 18, 2017, which claims priority to and the benefit of, Chinese Patent Application Serial No. 201710256210.0, filed Apr. 19, 2017, which are incorporated herein by reference in their entireties.

### FIELD OF THE INVENTION

The present invention relates to the ion guide technology, and in particular to an ion guide device and method as well as mass spectrometer.

### BACKGROUND OF THE INVENTION

It is well-known that quadrupole device is the ion optics most widely used in the various current commercial mass spectrometers. The quadrupole device has a very simple electrode structure. Generally, an ion transmission passageway is formed by arranging only two pairs of parallel rod-shaped electrodes at intervals, and a RF voltage V_{rf} and a DC voltage U_{dc} with opposite polarities are applied to the two pairs of rod-shaped electrodes to generate a quadrupole field therein for transmitting and screening ions. In practical applications, by adjusting the amplitude, frequency and the like of the RF voltage V_{rf} and the DC voltage U_{dc}, quadrupole rods can be used as various ion optics such as mass analyzers, ion guide devices, and ion collision and reaction devices. Mass analyzers are the earliest and also most important application of the quadrupole device. In 1953, Professor Wolfgang Paul et al. from the University of Bonne in Germany proposed the use of electric-field-based quadrupole mass analyzer to separate ions with different mass-to-charge ratios. The related devices and methods may refer to U.S. Pat. No. 2,939,952. Since then, the quadrupole mass analyzer gradually becomes the most common ion separation mean used in the mass spectrometer. So far, in the mainstream mass spectrometers including single-quadrupole mass spectrometer, triple-quadrupole mass spectrometer, and quadrupole time-of-flight mass spectrometer, as the core components, the quadrupole devices still play a very important role and have a huge application market.

As described above, in addition to the mass analyzers, the quadrupole devices are widely used as ion guide devices for the mass spectrometers to realize efficient ion transmission over different pressure intervals and extremely excellent ion beam compression effects. Generally, when the quadrupole device is used as ion guide device, RF voltages with opposite polarities are applied to only two pairs of rod-shaped electrodes in order to confine ions in the radial direction; meanwhile, to be convenient for ions to enter and leave the quadrupole rods in an axial direction, an identical bias voltage U_{bias} is often applied to all electrodes, so as to establish an axial potential gradient at the entrance and the exit. Under normal circumstances, ions pass through the quadrupole rods mainly by means of the initial kinetic energy obtained during entering the quadrupole rods. When the pressure is low, there are few times for ions to collide with neutral gas molecules, and the loss of kinetic energy of ions is also low, so that the ions can quickly pass through the quadrupole rods. However, when the gas pressure rises, since the loss of kinetic energy resulted from frequent collision of ions with molecules is very high, it takes a very long period of time or even impossible for the ions to pass through the quadrupole rods by only the initial kinetic energy of the ions. Thus, the sensitivity of instruments will be reduced, and the analysis speed will also be influenced greatly. For example, in an operating mode of alternately switching between positive and negative polarities, a mass spectrometer needs to periodically empty and fill ions, but the flight time of ions limits the minimal time for the instruments to obtain stable output.

In addition to the mass analyzer and ion guide device, ion collision/reaction cell is also a very important application of the quadrupole device. The ion collision/reaction cell is mainly the device for colliding the precursor ions with molecules for dissociation reaction, and then analyzing the resulting product ions to obtain the structural information of precursor ions or to improve the detection selectivity and sensitivity.

By taking the collision induced dissociation as an example, generally, ions accelerated by an electric field are fed into an collision cell which is filled with a collision gas (argon, nitrogen or helium) and maintained at a certain pressure (1 to 2 Pa); and then, the ions are collided with gas molecules so that part of kinetic energy is converted into internal energy, so that some chemical bonds are broken and a plurality of fragment ions are generated. Due to the excellent ion focusing capability, the quadrupole device is often used as collision cell. Like common ion guide devices, in order to facilitate ions to pass through the collision cell and improve the analysis speed, it is required to establish an axial electric field for driving ion transmission. In U.S. Pat. No. 7,675,031, Michael Knoicek et el. have proposed a structure having a plurality of auxiliary electrodes interposed between adjacent electrodes of quadrupole device, wherein an axial DC potential gradient is applied to the auxiliary electrodes to generate an axial electric field for driving ion transmission. Meanwhile, this patent has further disclosed a curved structure based on this technique. It is well-known that using a curved ion guide device as well as a curved collision cell, are not only beneficial for reducing the interference from the neutral noise but also convenient for the overall design of the instrument to reduce the area occupancy of the instrument. Therefore, many commercial instruments use various curved ion guide devices.

However, in order to improve the dissociation efficiency of ions, the incident kinetic energy of ions is very high, generally dozens or hundreds of volts. If a collision cell is of a curved structure, high-speed incident ions are often too fast to be deflected by the RF voltage, and instead, they directly collide onto the electrodes to cause ion loss. However, if the RF voltage is increased, the mass range of ions that can pass through will be narrowed, and as a result, the generated fragment ions are difficult to pass through.

In order to solve this problem, in U.S. Pat. No. 8,084,750, Felician Muntean has proposed a method of applying a radial DC electric field in a curved quadrupole ion guide, for providing a centrifugal force for the deflection of ions. Meanwhile, this radial deflection electric field is gradually reduced from the entrance to the exit, so that the ion transmission efficiency and the mass window width can be optimized globally. This method can provide both an axial driving electric field and a radial deflection electric field, and is very suitable for curved collision cell. Two typical structures of this method are as follows: all electrodes of a quadrupole ion guide based on square rods are divided into a plurality of segments, and two adjacent electrodes in the quadrupole ion guide are divided into a plurality of segments. The former structure is relatively complicated and also difficult to assemble. However, it is relatively convenient to apply a voltage, so that a proportion of the axial driving electric field and the radial deflection electric field may be controlled conveniently. The latter structure is relatively simple. However, the size of components of the two electric fields cannot be separately controlled, and the overall performance of the device is difficult to optimize.

### SUMMARY OF THE INVENTION

In view of the deficiencies in the prior arts, an objective of the present invention is to provide an ion guide device and associated method as well as a mass spectrometer in order to solve the problems in the prior arts.

To achieve this objective and other objectives, the present invention provides an ion guide device, including: a first electrode assembly, including at least one pair of first electrode units parallelly arranged along a spatial axis; a second electrode assembly, including at least one pair of second electrode units parallelly arranged along the said spatial axis, wherein each of the second electrode units includes a plurality of segmented electrodes arranged in the axial direction, and an ion transmission channel in the axial direction is formed within a space surrounded by the first electrode assembly and the second electrode assembly; and, a power supply device configured to apply a RF voltage to one of the first electrode assembly and the second electrode assembly or separately apply RF voltages with different polarities to the first electrode assembly and the second electrode assembly so that a RF field is formed in a direction perpendicular to the said spatial axis to confine ions, and apply a DC voltage to at least part of the said segmented electrodes of the second electrode assembly so that a DC potential gradient is formed inside the ion transmission channel.

In an embodiment of the present invention, the spatial axis is a straight axis, a curve axis or a combination of the both.

In an embodiment of the present invention, each of the first electrode units at least includes one electrode or a plurality of electrodes.

In an embodiment of the present invention, surfaces of the first electrode assembly and the second electrode assembly facing the spatial axis are parallel or perpendicular.

In an embodiment of the present invention, at least part of electrodes in the first electrode assembly and the second electrode assembly are one or more of plate-shaped electrodes, rod-shaped electrodes, and thin-layer electrodes attached to a PCB or a ceramic substrate.

In an embodiment of the present invention, the included angle between a distribution direction of the plurality of segmented electrodes and the axial direction remains unchanged or changes gradually.

In an embodiment of the present invention, at least two of the plurality of segmented electrodes are identical in at least one of size or shape.

In an embodiment of the present invention, the waveform of the RF voltage is at least one of sine wave, square wave, sawtooth wave and triangular wave.

In an embodiment of the present invention, the RF voltages with different polarities are RF voltages which are opposite in polarity and identical in amplitude and frequency, or RF voltages which are different in at least one of phase, amplitude and frequency.

In an embodiment of the present invention, the RF field is a quadrupole field or a multipole field.

In an embodiment of the present invention, a pressure value of the gas is within one of the following ranges: a) 2×10⁵ Pa to 2×10³ Pa; b) 2×10³ Pa to 20 Pa; c) 1 Pa to 2 Pa; d) 2 Pa to 2×10⁻¹ Pa; e) 2×10⁻¹ Pa to 2×10⁻³ Pa; and, f)<2×10⁻³ Pa.

To achieve this objective and other objectives, the present invention provides an ion guide device, including: a first electrode assembly, including at least one pair of first electrode units parallelly arranged along a spatial axis; a second electrode assembly, including at least one pair of second electrode units parallelly arranged along the said spatial axis, wherein a high-resistance material layer is coated on a surface of each of the second electrode units facing the spatial axis, and an ion transmission channel in the axial direction is formed within a space surrounded by the first electrode assembly and the second electrode assembly; and, a power supply device configured to apply a RF voltage to one of the first electrode assembly and the second electrode assembly or separately apply RF voltages with different polarities to the first electrode assembly and the second electrode assembly so that a RF field is formed in a direction perpendicular to the spatial axis to confine ions, and apply a DC voltage to the second electrode assembly so that a DC potential gradient in the axial direction is formed inside the ion transmission channel.

In an embodiment of the present invention, the spatial axis is a straight axis, a curve axis or a combination of the both.

In an embodiment of the present invention, each of the first electrode units at least includes one electrode or a plurality of electrodes.

In an embodiment of the present invention, surfaces of the first electrode assembly and the second electrode assembly facing the spatial axis are parallel or perpendicular.

In an embodiment of the present invention, at least part of electrodes in the first electrode assembly and the second electrode assembly are one or more of plate-shaped electrodes, rod-shaped electrodes, and thin-layer electrodes attached to a PCB or a ceramic substrate.

In an embodiment of the present invention, the included angle between an extension direction of the second electrode units and the axial direction remains unchanged or changes gradually.

In an embodiment of the present invention, the waveform of the RF voltage is at least one of sine wave, square wave, sawtooth wave and triangular wave.

In an embodiment of the present invention, the RF voltages with different polarities are RF voltages which are opposite in polarity and identical in amplitude and frequency, or RF voltages which are different in at least one of phase, amplitude and frequency.

In an embodiment of the present invention, the RF field is a quadrupole field or a multipole field.

In an embodiment of the present invention, the pressure value of the gas is within one of the following ranges: a) 2×10⁵ Pa to 2×10³ Pa; b) 2×10³ Pa to 20 Pa; c) 1 Pa to 2 Pa; d) 2 Pa to 2×10⁻¹ Pa; e) 2×10⁻¹ Pa to 2×10⁻³ Pa; and, f)<2×10⁻³ Pa.

To achieve this objective and other objectives, the present invention provides a mass spectrometer, including: one or more ion guide devices described above, and the ion guide device is used as any one of the following devices: a) a preceding-stage ion guide device; b) an ion compression device; c) an ion storage device; d) a collision cell device; and, e) an ion buncher device.

To achieve this objective and other objectives, the present invention provides an ion guide method, including the steps of: providing a first electrode assembly and a second electrode assembly, the first electrode assembly including at least one pair of first electrode units parallelly arranged along a spatial axis, the second electrode assembly including at least one pair of second electrode units parallelly arranged along the said spatial axis, wherein each of the second electrode units includes a plurality of segmented electrodes arranged in the axial direction, and an ion transmission channel in the axial direction is formed within a space surrounded by the first electrode assembly and the second electrode assembly; and, applying a RF voltage to one of the first electrode assembly and the second electrode assembly or separately applying RF voltages with different polarities to the first electrode assembly and the second electrode assembly so that a RF field is formed in a direction perpendicular to the spatial axis to confine ions, and applying a DC voltage to at least part of segmented electrodes of the second electrode assembly so that a DC potential gradient is formed inside the ion transmission channel.

To achieve this objective and other objectives, the present invention provides an ion guide method, including the steps of: providing a first electrode assembly and a second electrode assembly, the first electrode assembly including at least one pair of first electrode units parallelly arranged along a spatial axis, the second electrode assembly including at least one pair of second electrode units parallelly arranged along the said spatial axis, wherein a high-resistance material layer is coated on a surface of each of the second electrode units facing the spatial axis, and an ion transmission channel in the axial direction is formed within a space surrounded by the first electrode assembly and the second electrode assembly; and, applying a RF voltage to one of the first electrode assembly and the second electrode assembly or separately applying RF voltages with different polarities to the first electrode assembly and the second electrode assembly so that a RF field is formed in a direction perpendicular to the spatial axis to confine ions, and applying a DC voltage to the second electrode assembly so that a DC potential gradient is formed inside the ion transmission channel.

In conclusion, in the ion guide device and method and the mass spectrometer provided by the present invention, a pair of parallel electrode assemblies, among the electrode assemblies surrounded a spatial axis to form an ion transmission channel, is segmented in a certain direction, so that a DC voltage can be separately applied to the segmented electrodes to form a DC potential gradient. In this way, not only an electric field driving component in an axial direction but also an electric field component perpendicular to the axial direction can be provided to control the motion of ions in the ion transmission channel. As a result, the problems of low analysis speed, limited ion incident energy, difficulty to balance the device structure simplification and the performance optimization and the like are solved.

### BRIEF DESCRIPTION OF THE DRAWINGS

FIG. 1 shows a structure diagram of an ion guide device according to Embodiment 1 of the present invention.

FIG. 2 shows a structure diagram of an ion guide device according to Embodiment 2 of the present invention.

FIG. 3 shows a structure diagram of an ion guide device according to Embodiment 3 of the present invention.

FIG. 4 shows a structure diagram of a first electrode assembly according to Embodiment 3 of the present invention.

FIG. 5 shows a structure diagram of an ion guide device according to Embodiment 4 of the present invention.

FIG. 6 shows a structure diagram of a first electrode assembly according to Embodiment 4 of the present invention.

FIG. 7 shows a structure diagram of a first electrode assembly according to Embodiment 5 of the present invention.

FIG. 8 shows a structure diagram of a first electrode assembly according to Embodiment 6 of the present invention.

FIG. 9 shows a structure diagram of an ion guide device according to Embodiment 7 of the present invention.

FIG. 10 is a top view of FIG. 9.

FIG. 11 shows a structure diagram of an ion guide device according to Embodiment 8 of the present invention.

FIG. 12 shows a structure diagram of an ion guide device according to Embodiment 9 of the present invention.

### DETAILED DESCRIPTION OF THE INVENTION

Implementations of the present invention will be described below by specific embodiments, and other advantages and effects of the present invention may be easily obtained by those skilled in the art from the contents disclosed in the description.

It is to be noted that, the structure, scale, size and the like shown in the accompanying drawings of the description are merely used for allowing those skilled in the art to understand and read the contents disclosed in the description and not intended to limit the implementable conditions of the present invention, and thus have no any technically substantive meaning. Without influencing the effects and objectives which may be achieved by the present invention, any structural modification, changes in scale, or size adjustments shall fall into the scope defined by the technical contents of the present invention. Meanwhile, terms such as “upper”, “lower”, “left”, “right”, “middle” and “one” used in the description are merely used for clear statement and not intended to limit the implementable scope of the present invention, and any changes or adjustments in relative relations shall be regarded as falling to the implementable scope of the present invention without substantively changing the technical contents.

### Embodiment 1

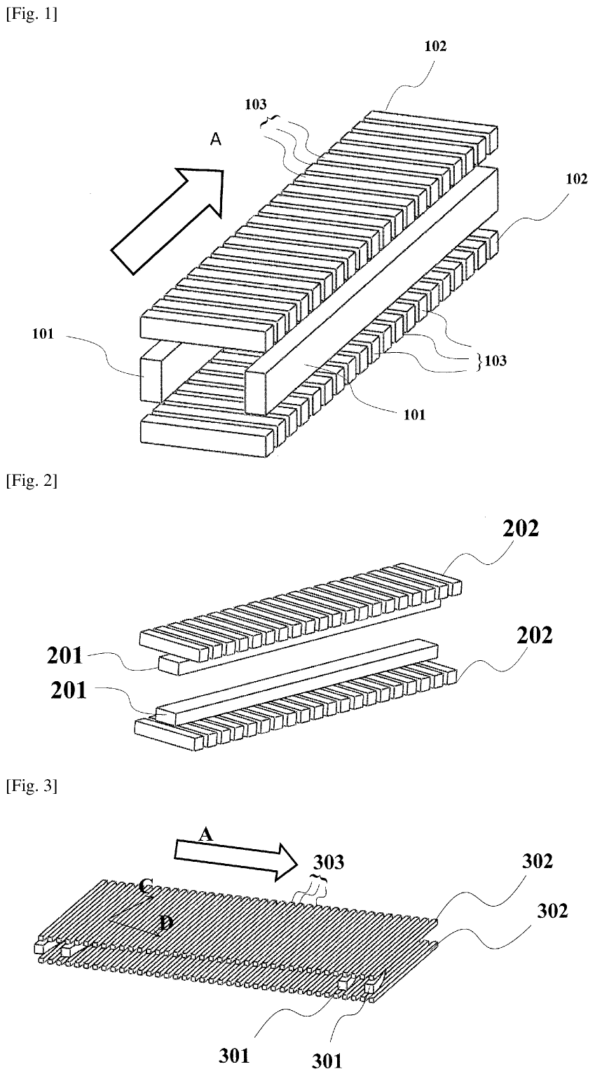

As shown in FIG. 1, the present invention provides an ion guide device, including: a first electrode assembly, a second electrode assembly and a power supply device.

In this embodiment, the first electrode assembly includes at least one pair of first electrode units 101 parallelly arranged along a spatial axis. The first electrode units 101 may be one-piece to which an identical voltage is applied.

In this embodiment, the second electrode assembly includes at least one pair of second electrode units 102 parallelly arranged in parallel in the axial direction, wherein each of the second electrode units 102 includes a plurality of segmented electrodes 103 arranged in the axial direction.

An ion transmission channel in the axial direction is formed within a space surrounded by the first electrode assembly and the second electrode assembly. In this embodiment, the surfaces of the first electrode assembly and the second electrode assembly facing the spatial axis are perpendicular, so as to enclose the ion transmission channel. It is to be particularly noted that, in other embodiments, the ion transmission channel is not necessarily enclosed by the first electrode assembly and the second electrode assembly, for example, as shown in Embodiment 2, and is not limited to the structure in Embodiment 1.

The power supply device may provide a RF voltage output to apply a RF voltage to either of the first electrode assembly and the second electrode assembly or separately apply RF voltages with different polarities to the first electrode assembly and the second electrode assembly, so that a RF field is formed in a direction (e.g., a radial direction) perpendicular to the said spatial axis to confine ions.

For example, in an embodiment, the power supply device may apply a RF voltage with a first polarity to two first electrode units 101 and apply a RF voltage with a second polarity to two second electrode units 102 (i.e., the segmented electrodes 103), so that a quadrupole RF field is formed for confining ions within the ion transmission channel, wherein the RF voltages with different polarities are RF voltages which are opposite in polarity and identical in amplitude and frequency, or RF voltages which are different in at least one of phase, amplitude and frequency. In addition, the waveform of the RF voltages is at least one of sine wave, square wave, sawtooth wave and triangular wave.

Of course, the above description is illustrative. The RF field may change according to different structures of the first electrode assembly and the second electrode assembly. Other multipole fields may be formed. It is not limited to this embodiment.

Moreover, the power supply device may further provide a DC voltage output to apply a DC voltage to at least part of segmented electrodes 103 of the second electrode assembly so that a DC potential gradient is formed inside the ion transmission channel (e.g., a direction indicated by an arrow A).

It is to be noted that the power supply device does not consist of a single power supply component, and instead, it may contain a plurality of power supply components, part of which outputs a RF voltage while the other part of which outputs a DC voltage.

Principally, the ion guide device provided by the present invention may change the value of the stable parameter a of each position within the ion transmission channel while generating an axial driving electric field. According to the Mathieu equation:

$$\frac{{d}^{2} u}{d {ξ}^{2}} + {}_{( )}^{}{a}{}_{u}^{} \vert 2 q 2 ξs u = 0 \qquad ( 1 )$$

where u denotes x and y coordinates of a plane of the quadrupole field,

ξ=Ωt/2

is a dimensionless parameter,

Ω=2πf

is a RF circular frequency, t denotes the time, and a and q are stable parameters in the quadrupole mass analyzer theory and correspond to a RF voltage V_{rf} and a DC voltage U_{dc}, respectively, with reference to the following formulae:

$$\vert 4 {eV}_{f} \\ {a}_{x} = \vert {a}_{y} = \frac{8 e {U}_{d c}}{m {r}_{0}^{2} {Ω}^{2}} , \qquad ( 2 )$$

It can be seen that, when the DC voltage U_{dc} is different, the value of the stable parameter a changes correspondingly. Therefore, when a gradually reduced DC voltage is applied to the segmented electrodes 103, the value of a, which is gradually reduced in the axial direction, may be obtained for ions with a fixed mass-to-charge ratio. In accordance with a stabilization diagram of the quadrupole mass analyzer, when proper values of a and q are used, ions with different mass-to-charge ratios may be screened. That is, particular ions are allowed to stably pass through the quadrupole rod, while some ions are not allowed to pass through the quadrupole rod due to the loss of stability of motion in the radial direction. Therefore, the ion guide device provided by the present invention may provide an axial driving electric field, and may also specifically remove ions with a certain particular mass-to-charge ratio from a particular region of the ion transmission channel so as to reduce chemical noise. Meanwhile, with the decrease of the value of a, survival ions are more and more stable, so that very excellent ion focusing effect may be achieved.

Optionally, at least two of the plurality of segmented electrodes 103 are identical in at least one of size or shape. Although the segmented electrodes 103 shown in FIG. 1 are flat electrodes which are identical in shape and size, in other embodiments, part or all of the segmented electrodes 103 may be identical only in size, or identical only in shape, and are not limited to the shown example.

Optionally, the ion guide device may operate at a particular pressure, and effectively improve the transmission speed of ions. The pressure value may be within one of the following ranges: a) 2×10⁵ Pa to 2×10³ Pa; b) 2×10³ Pa to 20 Pa; c) 1 Pa to 2 Pa; d) 2 Pa to 2×10⁻¹ Pa; e) 2×10⁻¹ Pa to 2×10⁻³ Pa; and, f)<2×10⁻³ Pa, wherein particularly when the ion guide device operates at a pressure over 1 Pa, the transmission time of ions can be effectively reduced to below 1 ms or even less.

In an embodiment, comprehensively considering the processing difficulty level, performance requirement and other practical factors, the first and second electrode assemblies may be in various forms such as plate-shaped electrodes, rod-shaped electrodes, or thin-layer electrodes attached to a PCB or a ceramic substrate.

### Embodiment 2

FIG. 2 shows another embodiment of the ion guide device provided by the present invention, wherein a difference between this embodiment and Embodiment 1 mainly lies in that inner surfaces of the first electrode assembly and the second electrode assembly facing the axial direction are parallel. It can be seen from the shown structure that the pair of first electrode units 201 is parallel to a pair of second electrode units 202. When a same voltage application way is adopted, a radial quadrupole field and an axial DC electric field can also be generated inside the ion transmission channel. Such a structure is very suitable for planar processing processes, for example, PCB process.

The spatial axis is not limited to a straight axis, and it can be a form of a curve axis or a combination of the straight axis and the curve axis. This will be described in Embodiment 3 and Embodiment 4.

### Embodiment 3

As shown in FIGS. 3 and 4, FIG. 3 shows a structure of an ion guide device having a spatial axis deflected by 180 degrees, and FIG. 4 shows a structure of a first electrode assembly of FIG. 3, where the first electrode assembly consists of two arc-shaped first electrode units 301 which are bent by 180 degrees, and ions are transmitted from the arc-shaped ion transmission channel between the two first electrode units 301.

The advantage of the curve axis lies in that an included angle between a segmentation direction of the segmented electrodes 301 of the second electrode units 302 and the direction of the spatial axis always changes. As shown in FIG. 3, this included angle at the ion entrance is 0 degree. In this case, the DC electric field does not provide an axial driving force, i.e., a radial acting force completely used for assisting ion deflection. As the ions move forward, the included angle changes gradually, so that the component of the axial driving electric field and the component of the radial electric field also increase. Correspondingly, a ratio of the axial driving force to the radial acting force also increases.

When the ion guide device in this embodiment is used as a collision cell, since the initial incident kinetic energy of ions is very high, almost no axial driving force is required. Instead, a radial acting force is highly required to assist ion deflection and prevent ions from colliding onto the electrodes because they are too fast to be deflected. When ions move forward for a certain distance, due to the collision of ions with neutral gas molecules, the kinetic energy of ions is lost gradually, and a certain axial driving force (for example, generated by an axial DC electric field component in a direction indicated by an arrow C) is highly required in this case. Almost no radial acting force (for example, generated by a radial DC electric field component in a direction indicated by an arrow D) is required. Apparently, the device in this embodiment exactly meets such a requirement of the collision cell.

In addition, the ion guide device with the curve axis may reduce the neutral noise and decrease the area occupancy of the instrument.

### Embodiment 4

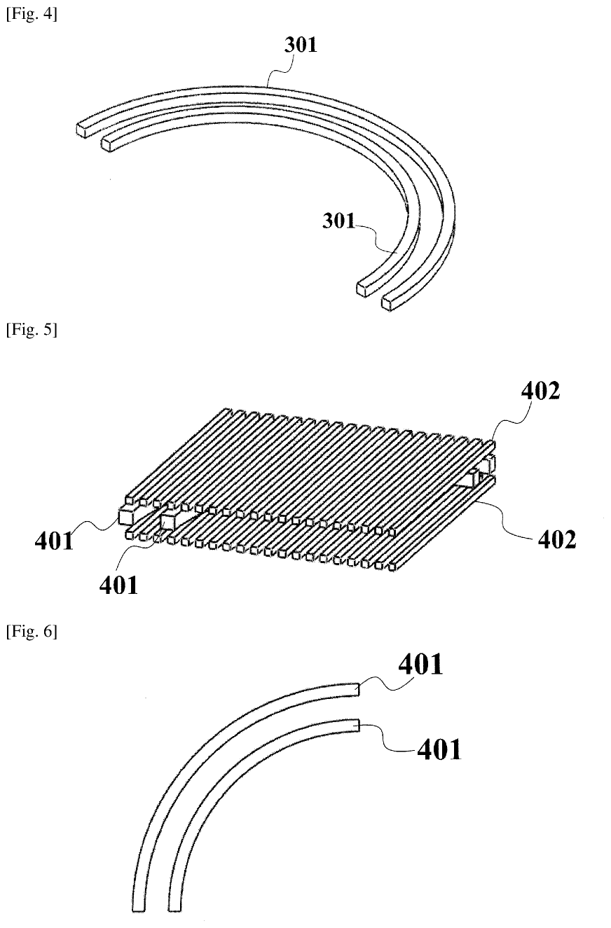

As shown in FIGS. 5 and 6, a variation embodiment of Embodiment 3 is provided.

FIG. 5 shows a structure of an ion guide device having a spatial axis deflected by 90 degrees, including one pair of first electrode units 401 and second electrode units 402; and FIG. 6 shows a structure of the first electrode assembly of FIG. 5, where the first electrode assembly consists of two arc-shaped first electrode units 401 which are bent by 90 degrees.

The ion guide device in this embodiment has a smaller size than that in Embodiment 3, and may adopt any combination of a plurality of ion guide devices, which is flexible. For example, the ion guide devices in two embodiments may be combined to form the ion guide device in FIG. 3.

The first electrode units may be one-piece, or may consist of segmented electrodes to which different DC voltages are applied. Embodiments 5 and 6 will be described hereinafter.

### Embodiment 5

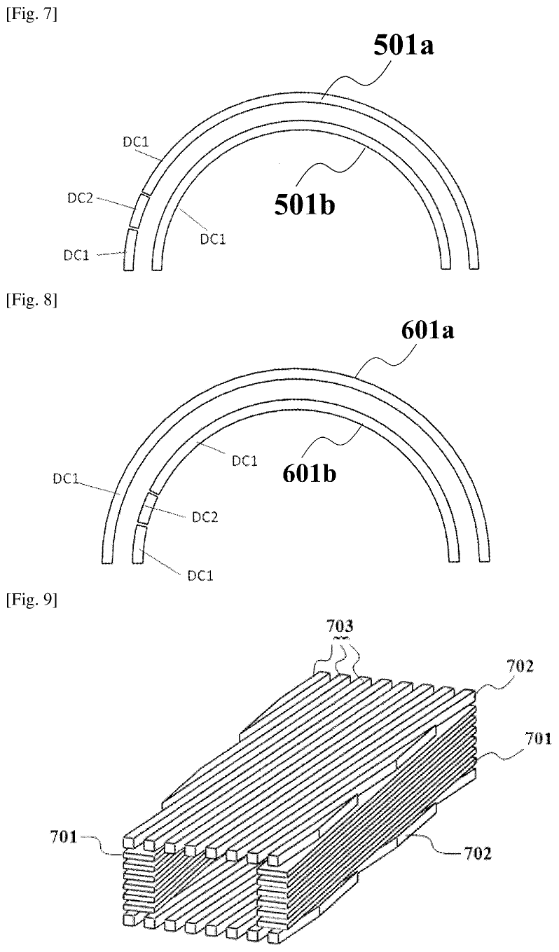

As shown in FIG. 7, a pair of electrodes units 501a and 501b is arc-shaped. The outer first electrode unit 501a is divided into a plurality of segmented electrodes in the vicinity of the entrance of the ion transmission channel, while the inner first electrode unit 501b is not segmented. In this embodiment, the first electrode unit 501a is divided into three segmented electrodes, where a DC voltage DC1 is applied to the segmented electrodes on the two sides and a DC voltage DC2 is applied to the segmented electrode in the middle. The inner first electrode unit 501b may be one-piece, and a DC voltage DC1 is applied to the inner first electrode unit 501b. The purpose of independently adjusting the DC2 in such a segmented structure is that, when the incident kinetic energy of ions is high, changing the DC2 can provide an additional radial acting force for assisting the ion deflection so as to reduce the loss of ions. Meanwhile, since ions frequently collide with gas molecules after entering the ion transmission channel, the kinetic energy of ions will decrease quickly. Therefore, the ion deflection may be effectively assisted just by performing simple segmentation in the vicinity of the entrance.

### Embodiment 6

As shown in FIG. 8, a difference between this embodiment and Embodiment 5 lies in that the outer first electrode unit 601a in the first electrode assembly is not segmented, while the inner first electrode unit 601b is segmented. The principle is similar to that in Embodiment 5, and will not be repeated here.

### Embodiment 7

As shown in FIG. 9, in the ion guide device provided in this embodiment, each second electrode unit in a pair of second electrode units 702 in the second electrode assembly consists of a plurality of first segmented electrodes 703 which are flat electrodes; the plurality of first segmented electrodes 703 are parallelly arranged in a segmentation direction deviated from the axial direction (for example, indicated by an arrow E, also called a DC potential gradient direction); and, when RF voltages with opposite polarities are applied to adjacent first segmented electrodes 703, a multipole field may be formed.

Meanwhile, the ion guide device in this embodiment includes multiple pairs of first electrode units 701, and RF voltages with opposite polarities are applied to adjacent first electrode units.

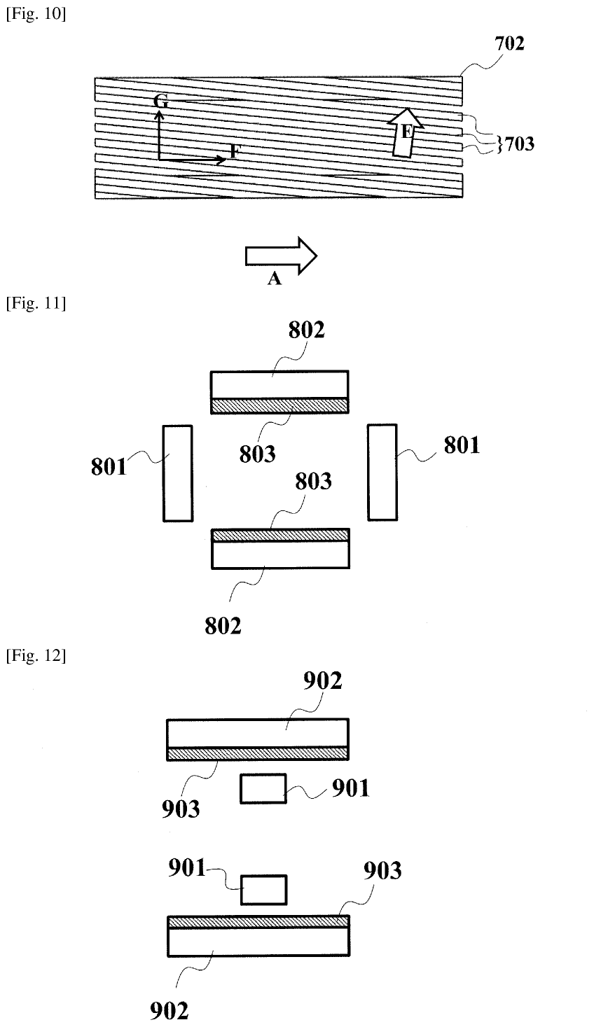

In this case, the segmentation direction of the second electrode assembly is neither perpendicular nor parallel to the spatial axis. Thus, both an axial driving electric field component (indicated by an arrow F) and a lateral DC electric field component (indicated by an arrow G) may be generated within the ion transmission channel to push ions to one side. Specifically, FIG. 10 shows a planar structure of the ion guide device in this embodiment. Similarly, when the spatial axis is a curve axis, the device may be of a curved structure. Such an ion guide device structure has the following advantage: an off-axis ion optics may be formed to push incident ions to the vicinity of the electrodes to which a RF voltage is applied on one side, and certain ion beam compression effects may be realized. In addition, it is well-known that the operating pressure of the multipole field is much higher than that of the quadrupole field. Therefore, this device may adapt to higher operating pressure.

The segmented electrode structure of the second electrode units is not necessary, and the second electrode units may be implemented by some alternative schemes in other embodiments, for example, by coating high-resistance material.

### Embodiment 8

As shown in FIG. 11, a main difference between this embodiment and the preceding embodiments lies in that a high-resistance material layer 803 is coated on an inner surface of each of the second electrode units 802 facing the spatial axis, and the first electrode units 801 and the second electrode units 802 are designed in such a structure that inner surfaces thereof facing the spatial axis are perpendicular.

### Embodiment 9

As shown in FIG. 12, a main difference between this embodiment and Embodiment 8 lies in that the first electrode units 901 and the second electrode units 902 are designed in such a structure that inner surfaces thereof facing the spatial axis are parallel, and a high-resistance material layer 903 is coated on an inner surface of each of the second electrode units 902 facing the spatial axis.

The preceding Embodiments 2 to 7 may be applied to Embodiments 8 and 9. By designing a corresponding pattern for the high-resistance material layer and rationally selecting a voltage application position, it is possible to achieve the DC potential gradient effects similar to those that can be achieved by a segmented electrode structure without using the segmented electrode structure. Compared with the structure in Embodiment 1, this embodiment is more convenient to apply a DC voltage.

In combination with the above embodiments, the present invention further provides a mass spectrometer, including: one or more ion guide devices, and the ion guide device is used as any one of the following devices: a) a preceding-stage ion guide device; b) an ion compression device; c) an ion storage device; d) a collision cell device; and, e) an ion buncher device.

In conclusion, in the ion guide device and associated method as well as the mass spectrometer provided by the present invention, a pair of parallel electrode assemblies, among electrode assemblies surrounding a spatial axis to form an ion transmission channel, is segmented in a certain direction, so that a DC voltage can be separately applied to the segmented electrodes to form a DC potential gradient. In this way, not only an electric field driving component in an axial direction but also an electric field component perpendicular to the axial direction can be provided to control the motion of ions in the ion transmission channel. As a result, the problems of low analysis speed, limited ion incident energy, difficulty to balance the device structure simplification and the performance optimization and the like are solved.

The embodiments are merely for illustratively describing the principle and effects of the present invention, and not intended to limit the present invention. Those skilled in the art may make modifications or alterations to the embodiments without departing from the spirit and scope of the present invention. Therefore, all equivalent modifications or alterations made by those skilled in the art without departing from the spirit and technical idea of the present invention shall be embraced by the claims of the present invention.

1. An ion guide device, comprising:
a first electrode assembly, comprising at least one pair of first electrode units parallelly arranged along a spatial axis;
a second electrode assembly, comprising at least one pair of second electrode units parallelly arranged along the said axis, wherein each of the said second electrode units comprises a plurality of segmented electrodes arranged along the said axis, and
an ion transmission channel along the said axis is formed within a space surrounded by the said first electrode assembly and second electrode assembly; and
a power supply device configured to apply a RF voltage to either of the first electrode assembly and the second electrode assembly or separately apply RF voltages with different polarities to the first electrode assembly and the second electrode assembly so that a RF field is formed in a direction perpendicular to the said spatial axis to confine ions, and apply a DC voltage to at least part of said segmented electrodes of the second electrode assembly so that a DC potential gradient is formed inside the ion transmission channel.

2. The ion guide device according to claim 1, wherein the spatial axis is a straight axis, a curve axis or a combination thereof.

3. The ion guide device according to claim 1, wherein each of the first electrode units at least comprises one electrode or a plurality of electrodes.

4. The ion guide device according to claim 1, wherein the surfaces of the first electrode assembly and the second electrode assembly facing the spatial axis are parallel or perpendicular.

5. The ion guide device according to claim 1, wherein at least part of electrodes of the first electrode assembly and the second electrode assembly are one or more of plate-shaped electrodes, rod-shaped electrodes, and thin-layer electrodes attached to a PCB or a ceramic substrate.

6. The ion guide device according to claim 1, wherein the included angle between a distribution direction of the said plurality of segmented electrodes and the axial direction remains unchanged or changes gradually.

7. The ion guide device according to claim 1, wherein at least two of the said plurality of segmented electrodes are identical in at least one of size or shape.

8. The ion guide device according to claim 1, wherein the waveform of the said RF voltage is at least one of sine wave, square wave, sawtooth wave and triangular wave.

9. The ion guide device according to claim 1, wherein the said RF voltages with different polarities are RF voltages which are opposite in polarity and identical in amplitude and frequency, or RF voltages which are different in at least one of phase, amplitude and frequency.

10. The ion guide device according to claim 1, wherein the said RF field is a quadrupole field or a multipole field.

11. The ion guide device according to claim 1, wherein there is a gas within the said ion guide device, and the pressure value of the gas is within one of the following ranges: a) 2×10⁵ Pa to 2×10³ Pa; b) 2×10³ Pa to 20 Pa; c) 1 Pa to 2 Pa; d) 2 Pa to 2×10⁻¹ Pa; e) 2×10⁻¹ Pa to 2×10⁻³ Pa; and, f)<2×10⁻³ Pa.

12. An ion guide device, comprising:
a first electrode assembly, comprising at least one pair of first electrode units parallelly arranged along a spatial axis;
a second electrode assembly, comprising at least one pair of second electrode units parallelly arranged along the said axis, wherein a high-resistance material layer is coated on the surfaces of each of the second electrode units facing the spatial axis, and
an ion transmission channel along the said axis is formed within a space surrounded by the first electrode assembly and the second electrode assembly; and
a power supply device configured to apply a RF voltage to either of the first electrode assembly and the second electrode assembly or separately apply RF voltages with different polarities to the first electrode assembly and the second electrode assembly so that a RF field is formed in a direction perpendicular to the said spatial axis to confine ions, and apply a DC voltage to the second electrode assembly so that a DC potential gradient is formed inside the ion transmission channel.

13. The ion guide device according to claim 12, wherein the said spatial axis is a straight axis, a curve axis or a combination thereof.

14. The ion guide device according to claim 12, wherein each of the first electrode units at least comprises one electrode or a plurality of electrodes.

15. The ion guide device according to claim 12, wherein the surfaces of the first electrode assembly and the second electrode assembly facing the said spatial axis are parallel or perpendicular.

16. The ion guide device according to claim 12, wherein at least part of electrodes of the first electrode assembly and the second electrode assembly are one or more of plate-shaped electrodes, rod-shaped electrodes, and thin-layer electrodes attached to a PCB or a ceramic substrate.

17. The ion guide device according to claim 12, wherein the included angle between the extension direction of the second electrode units and the axial direction remains unchanged or changes gradually.

18. The ion guide device according to claim 12, wherein the waveform of the said RF voltage is at least one of sine wave, square wave, sawtooth wave and triangular wave.

19. The ion guide device according to claim 12, wherein the RF voltages with different polarities are RF voltages which are opposite in polarity and identical in amplitude and frequency, or RF voltages which are different in at least one of phase, amplitude and frequency.

20. The ion guide device according to claim 12, wherein the said RF field is a quadrupole field or a multipole field.

21. The ion guide device according to claim 12, wherein there is a gas within the said ion guide device, and the pressure value of the gas is within one of the following ranges: a) 2×10⁵ Pa to 2×10³ Pa; b) 2×10³ Pa to 20 Pa; c) 1 Pa to 2 Pa; d) 2 Pa to 2×10⁻¹ Pa; e) 2×10⁻¹ Pa to 2×10⁻³ Pa; and, f) <2×10⁻³ Pa.

22. A mass spectrometer, comprising: one or more ion guide devices according to claim 1, wherein the ion guide device being used as any one of the following devices: a) a preceding-stage ion guide device; b) an ion compression device; c) an ion storage device; d) a collision cell device; and, e) an ion buncher device.

23. An ion guide method, comprising the steps of:
providing a first electrode assembly and a second electrode assembly, the said first electrode assembly comprising at least one pair of first electrode units parallelly arranged along a spatial axis, the said second electrode assembly comprising at least one pair of second electrode units parallelly arranged along the said spatial axis, wherein each of the second electrode units comprises a plurality of segmented electrodes arranged along the said spatial axis, and an ion transmission channel along the said spatial axis is formed within a space surrounded by the first electrode assembly and the second electrode assembly; and
applying a RF voltage to either of the first electrode assembly and the second electrode assembly or separately applying RF voltages with different polarities to the first electrode assembly and the second electrode assembly so that a RF field is formed in a direction perpendicular to the said spatial axis to confine ions, and applying a DC voltage to at least part of segmented electrodes of the second electrode assembly so that a DC potential gradient is formed inside the ion transmission channel.

24. An ion guide method, comprising the steps of:
providing a first electrode assembly and a second electrode assembly, the first electrode assembly comprising at least one pair of first electrode units parallelly arranged along a spatial axis, the second electrode assembly comprising at least one pair of second electrode units parallelly arranged along the said spatial axis, wherein a high-resistance material layer is coated on a surface of each of the second electrode units facing the said spatial axis, and an ion transmission channel along the said spatial axis is formed within a space surrounded by the first electrode assembly and the second electrode assembly; and
applying a RF voltage to either of the first electrode assembly and the second electrode assembly or separately applying RF voltages with different polarities to the first electrode assembly and the second electrode assembly so that a RF field is formed in a direction perpendicular to the said spatial axis to confine ions, and applying a DC voltage to the second electrode assembly so that a DC potential gradient is formed inside the ion transmission channel.

25. A mass spectrometer, comprising: one or more ion guide devices according to claim 12, wherein the ion guide device being used as any one of the following devices: a) a preceding-stage ion guide device; b) an ion compression device; c) an ion storage device; d) a collision cell device; and, e) an ion buncher device.
